(19) United States
(12) Patent Application Publication
(10) Pub. No.: US 2024/0332560 A1
(43) Pub. Date: Oct. 3, 2024

(54) ELECTROCHEMICAL CELL STACKS INCLUDING INTERCONNECT END PLATES

(71) Applicant: BLOOM ENERGY CORPORATION, San Jose, CA (US)

(72) Inventors: Michael REISERT, Milpitas, CA (US); Richard A. VILLA, San Jose, CA (US); Cheng-Yu LIN, Cupertino, CA (US); Khuzema KHAIRULLAH, San Francisco, CA (US); Tad ARMSTRONG, Burlingame, CA (US); Harald HERCHEN, Los Altos, CA (US); Christopher LEE, Santa Clara, CA (US)

(21) Appl. No.: 18/620,195

(22) Filed: Mar. 28, 2024

Related U.S. Application Data
(60) Provisional application No. 63/492,869, filed on Mar. 29, 2023.

(51) Int. Cl. H01M 8/0258; C25B 13/02; C25B 13/07; H01M 8/0217; H01M 8/0276; H01M 8/12; H01M 8/2484

(52) U.S. Cl. CPC H01M 8/0258; C25B 13/02; C25B 13/07; H01M 8/0217; H01M 8/0276; H01M 8/2484; H01M 2008/1293

(57) ABSTRACT

An electrochemical cell stack includes electrochemical cells that each contain a fuel electrode, an air electrode and an electrolyte disposed therebetween, interconnects disposed between the electrochemical cells, and an interconnect end plate disposed over the fuel electrode of an outermost one of the electrochemical cells. The interconnect end plate includes a fuel side, an opposing air side, fuel ribs disposed on the fuel side and at least partially defining fuel channels, air ribs disposed on the air side and at least partially defining dummy air channels, fuel holes extending from the fuel side to the air side, and recessed ring seal regions disposed on the air side surrounding the fuel holes.

### FIELD

Aspects of the present disclosure relate generally to electrochemical cell stacks, such as fuel cell and electrolyzer cell stacks, and in particular, to stacks including fuel-side interconnect end plates.

### BACKGROUND

A typical solid oxide fuel cell stack includes multiple fuel cells separated by metallic interconnects (IC) which provide both electrical connection between adjacent cells in the stack and channels for delivery and removal of fuel and oxidant. For solid oxide fuel cells (SOFC), the metallic interconnects are commonly composed of Cr-based alloys. such as CrFe alloys, which have a composition of 95 wt % Cr-5 wt % Fe or Cr—Fe—Y having a 94 wt % Cr-5 wt % Fe-1 wt % Y composition. The CrFe and CrFeY alloys retain their strength and are dimensionally stable at typical solid oxide fuel cell operating conditions, e.g., 700-900° C. in both air and wet fuel atmospheres.

### SUMMARY

According to an embodiment, an electrochemical cell stack includes electrochemical cells that each contain a fuel electrode, an air electrode and an electrolyte disposed therebetween, interconnects disposed between the electrochemical cells, and an interconnect end plate disposed over the fuel electrode of an outermost one of the electrochemical cells. The interconnect end plate includes a fuel side, an opposing air side, fuel ribs disposed on the fuel side and at least partially defining fuel channels, air ribs disposed on the air side and at least partially defining dummy air channels, fuel holes extending from the fuel side to the air side, and recessed ring seal regions disposed on the air side surrounding the fuel holes.

According to another embodiment, an electrochemical cell stack column comprises a fuel manifold, an electrochemical cell stack, comprising electrochemical cells that each comprise a fuel electrode, an air electrode and an electrolyte disposed therebetween, interconnects disposed between the electrochemical cells, and an interconnect end plate disposed over the fuel electrode of an outermost one of the electrochemical cells, and at least one shim located between the interconnect end plate and the fuel manifold.

According to another embodiment, a method comprises providing interconnect end plate comprising a fuel side, an opposing air side, fuel ribs disposed on the fuel side and at least partially defining fuel channels, air ribs disposed on the air side and at least partially defining dummy air channels, fuel holes extending from the fuel side to the air side, and ring seal regions disposed on the air side surrounding the fuel holes. The method also comprises coating the air side of the interconnect end plate with a protective layer, and removing the protective layer from the ring seal regions of the interconnect end plate to form recessed ring seal regions.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1A is a perspective view of a SOFC stack, according to various embodiments of the present disclosure.

FIG. 1B is a cross-sectional view of a portion of the stack of FIG. 1A.

FIG. 2A is a top view of an air side of an interconnect, according to various embodiments of the present disclosure.

FIG. 2B is a top view of a fuel side of the interconnect of FIG. 2A.

FIG. 3A is a three dimensional view of a electrochemical cell column, according to various embodiments of the present disclosure.

FIGS. 3B, 3D, 3E and 3F are cross-sectional view of a portion of the electrochemical cell column of FIG. 3A, according to alternative embodiments of the present disclosure.

FIG. 3C is a top view of an air side of an interconnect end plate, according to various embodiments of the present disclosure.

### DETAILED DESCRIPTION

The present disclosure is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Electrochemical cell systems include fuel cell and electrolyzer cell systems. In a high temperature fuel cell system, such as a solid oxide fuel cell (SOFC) system, an oxidizing flow is passed through the cathode side of the fuel cell while a fuel flow is passed through the anode side of the fuel cell. The oxidizing flow is typically air, while the fuel flow can be a hydrogen (H₂) or a hydrocarbon fuel, such as methane, natural gas, ethanol, or methanol. The fuel cell, operating at a typical temperature between 750° C. and 950° C., enables the transport of negatively charged oxygen ions from the cathode flow stream to the anode flow stream, where the ion combines with either free hydrogen or hydrogen in a hydrocarbon molecule to form water vapor and/or with carbon monoxide to form carbon dioxide. The excess electrons from the negatively charged ion are routed back to the cathode side of the fuel cell through an electrical circuit completed between anode and cathode, resulting in an electrical current flow through the circuit. In an electrolyzer system, such as a solid oxide electrolyzer system, water (e.g., steam) is separated into hydrogen and oxygen by applying a voltage across the electrolyzer cells.

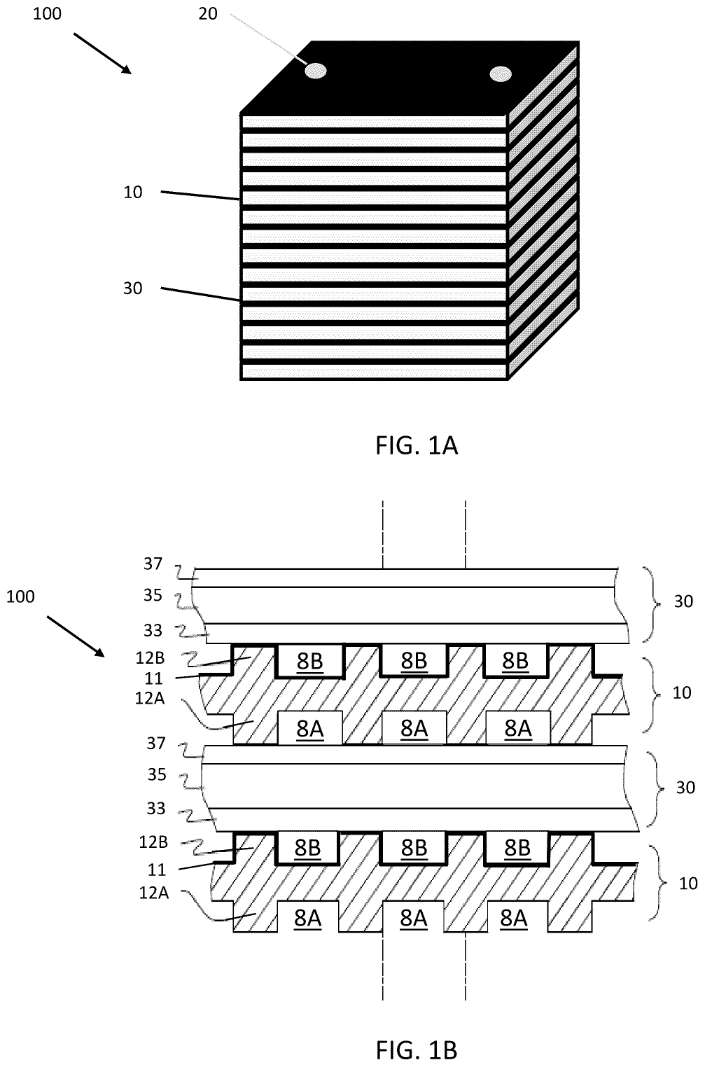

FIG. 1A is a perspective view of an electrochemical cell stack 100 and FIG. 1B is a sectional view of a portion of the stack 100, according to various embodiments of the present disclosure. In the embodiments below, the stack 100 is described as being operated as a solid oxide fuel cell (SOFC) stack 100. However, it should be noted that the stack 100 may also be operated as an electrolyzer (e.g., a solid oxide electrolyzer cell (SOEC) stack). Referring to FIGS. 1A and 1B, the stack 100 includes fuel cells 30 separated by interconnects 10. Referring to FIG. 1B, each fuel cell 30 comprises a cathode electrode 33, a solid oxide electrolyte 35, and an anode electrode 37.

Various materials may be used for the cathode electrode 33, electrolyte 35, and anode electrode 37. For example, the anode electrode 37 may comprise a cermet comprising a nickel containing phase and a ceramic phase. The nickel containing phase may consist entirely of nickel in a reduced state. This phase may form nickel oxide when it is in an oxidized state. Thus, the anode electrode 37 is preferably annealed in a reducing atmosphere prior to operation to reduce the nickel oxide to nickel. The nickel containing phase may include other metals in additional to nickel and/or nickel alloys. The ceramic phase may comprise a stabilized zirconia, such as yttria and/or scandia stabilized zirconia and/or a doped ceria, such as gadolinia, yttria and/or samaria doped ceria.

The electrolyte 35 may comprise a stabilized zirconia, such as scandia stabilized zirconia (SSZ) or yttria stabilized zirconia (YSZ). Alternatively, the electrolyte 35 may comprise another ionically conductive material, such as a doped ceria.

The cathode electrode 33 may comprise an electrically conductive material, such as an electrically conductive perovskite material, such as lanthanum strontium manganite (LSM). Other conductive perovskites, such as LSCo, etc., or metals, such as Pt, may also be used. The cathode electrode 33 may also contain a ceramic phase similar to the anode electrode 37. The electrodes and the electrolyte may each comprise one or more sublayers of one or more of the above described materials.

Fuel cell stacks 100 are frequently built from a multiplicity of SOFC's 30 in the form of planar elements, tubes, or other geometries. Although the fuel cell stack in FIG. 1A is vertically oriented, fuel cell stacks may be oriented horizontally or in any other direction. Fuel and air may be provided to the electrochemically active surface, which can be large. For example, fuel may be provided through fuel holes 20 formed in each interconnect 10. The fuel holes 20 may be aligned to form fuel conduits (i.e., fuel riser openings) that extend through the stack 100.

Each interconnect 10 electrically connects adjacent fuel cells 30 in the stack 100. In particular, an interconnect 10 may electrically connect the anode electrode 37 of one fuel cell 30 to the cathode electrode 33 of an adjacent fuel cell 30. FIG. 1B shows that the lower fuel cell 30 is located between two interconnects 10. An optional Ni mesh may be used to electrically connect the interconnect 10 to the anode electrode 37 of an adjacent fuel cell 30.

Each interconnect 10 includes fuel ribs 12A that at least partially define fuel channels 8A and air ribs 12B that at least partially define oxidant (e.g., air) channels 8B. The interconnect 10 may operate as a gas-fuel separator that separates a fuel, such as a hydrocarbon fuel, flowing to the fuel electrode (i.e., anode 37) of one cell in the stack from oxidant, such as air, flowing to the air electrode (i.e., cathode 33) of an adjacent cell in the stack.

Each interconnect 10 may be made of or may contain electrically conductive material, such as a metal alloy (e.g., chromium-iron alloy) which has a similar coefficient of thermal expansion to that of the solid oxide electrolyte in the cells (e.g., a difference of 0-10%). For example, the interconnects 10 may comprise a metal (e.g., a chromium-iron alloy, such as 4-6 weight percent iron, optionally 1 or less weight percent yttrium and balance chromium alloy) and may electrically connect the anode or fuel-side of one fuel cell 30 to the cathode or air side of an adjacent fuel cell 30. An electrically conductive contact layer, such as a nickel layer or mesh, may be provided between anode electrodes 37 and a fuel side of each interconnect 10. A protective layer 11, which may be formed of an electrically conductive material, such as lanthanum strontium manganite (LSM) and/or a spinel manganese cobalt oxide (MCO), may be provided on an air side of each interconnect 10.

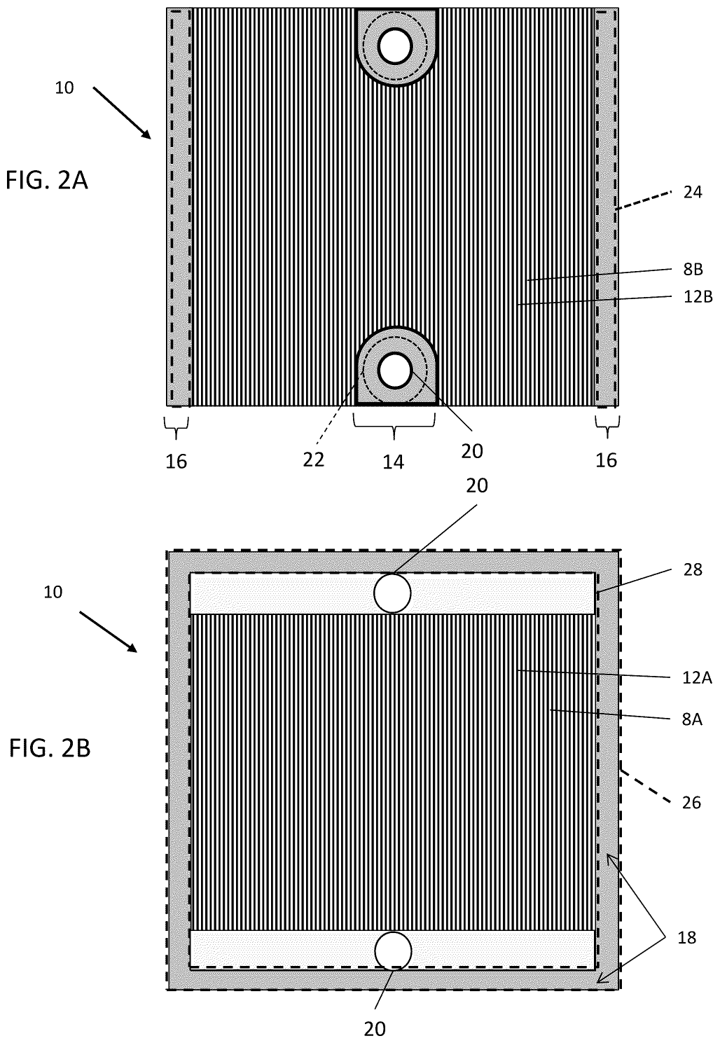

FIG. 2A is a top view of the air side of the interconnect 10, and FIG. 2B is a top view of a fuel side of the interconnect 10, according to various embodiments of the present disclosure. Referring to FIGS. 1B and 2A, the air side includes the air channels 8B. Air flows through the air channels 8B to a cathode electrode 33 of an adjacent fuel cell 30. The interconnect 10 may include ring seal regions 14 and strip seal regions 16. The seal regions 14, 16 may be flat surfaces that are coplanar with the tops of the air ribs 12B. Fuel holes 20 may be formed in the ring seal regions 14 and may extend through the interconnect 10. Ring seals 22 may be disposed on the ring seal regions 14 surrounding the fuel holes 20, to prevent fuel from contacting an adjacent cathode electrode 33. Strip seals 24 may be disposed on the strip seal regions 16. The seals 22, 24 may be formed of a glass or glass-ceramic material. The strip seal regions 16 may be an elevated plateau which does not include ribs or channels.

Referring to FIGS. 1B and 2B, the fuel side of the interconnect 10 may include the fuel channels 8A and fuel manifolds 28, which are surrounded by a frame seal region 18. The frame seal region 18 may be a flat region that is coplanar with the tops of the air ribs 12B. Fuel flows from one of the fuel holes 20 (e.g., inlet hole that forms part of the fuel inlet riser), into the adjacent manifold 28, through the fuel channels 8A, and to an anode 37 of an adjacent fuel cell 30. Excess fuel may flow into the other fuel manifold 28 and then into the other (e.g., outlet) fuel hole 20. A frame seal 26 may be disposed on the frame seal region 18. The frame seal 26 may be formed of a glass or glass-ceramic material.

Fuel is delivered through one of the fuel holes 20 to a corresponding manifold 28 that distributes the fuel to each fuel channel 8A. Fuel flows down each fuel channel 8A. Any unreacted fuel is collected in the other manifold 28 and exits the stack via the other fuel hole 20. This flow channel geometry may be optimized for operation on natural gas with partial external pre-reforming. In various embodiments, the interconnects 10 may be coated on one or both sides with a protective layer 11, such as a layer comprising lanthanum strontium manganite (LSM) and/or manganese cobalt oxide (MCO) spinel, which may be configured to limit chromium diffusion from the interconnects 10.

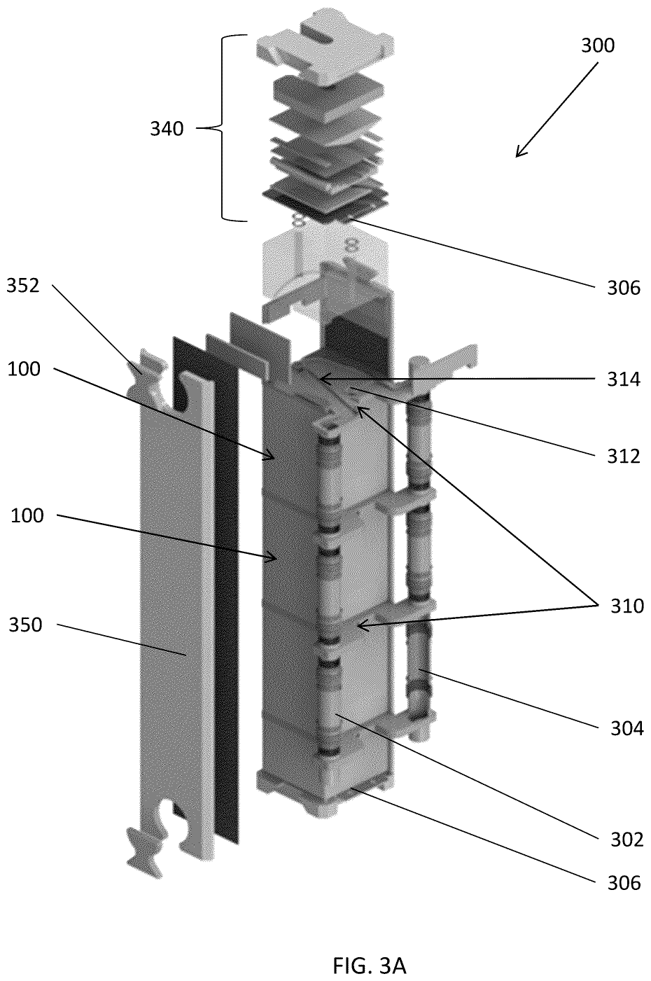

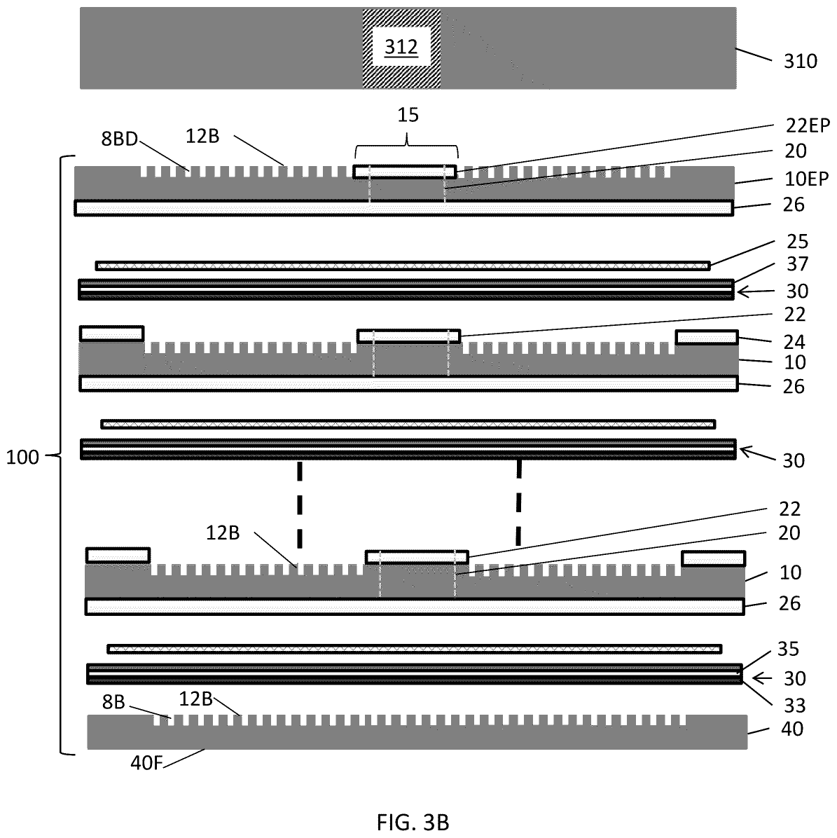

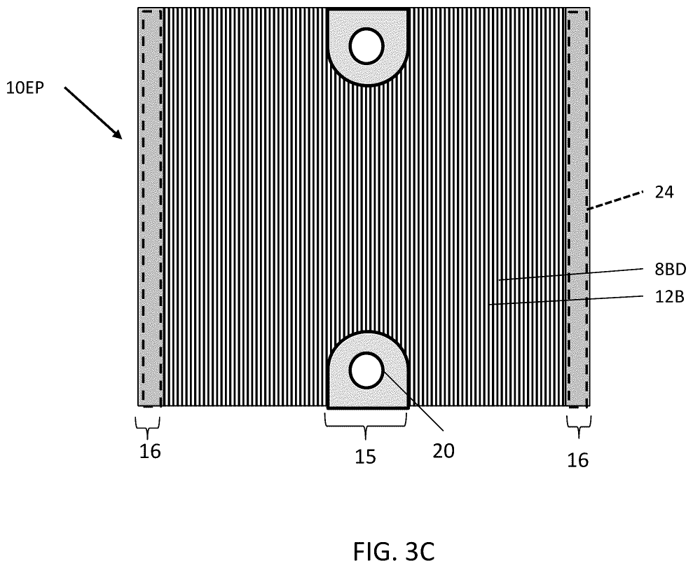

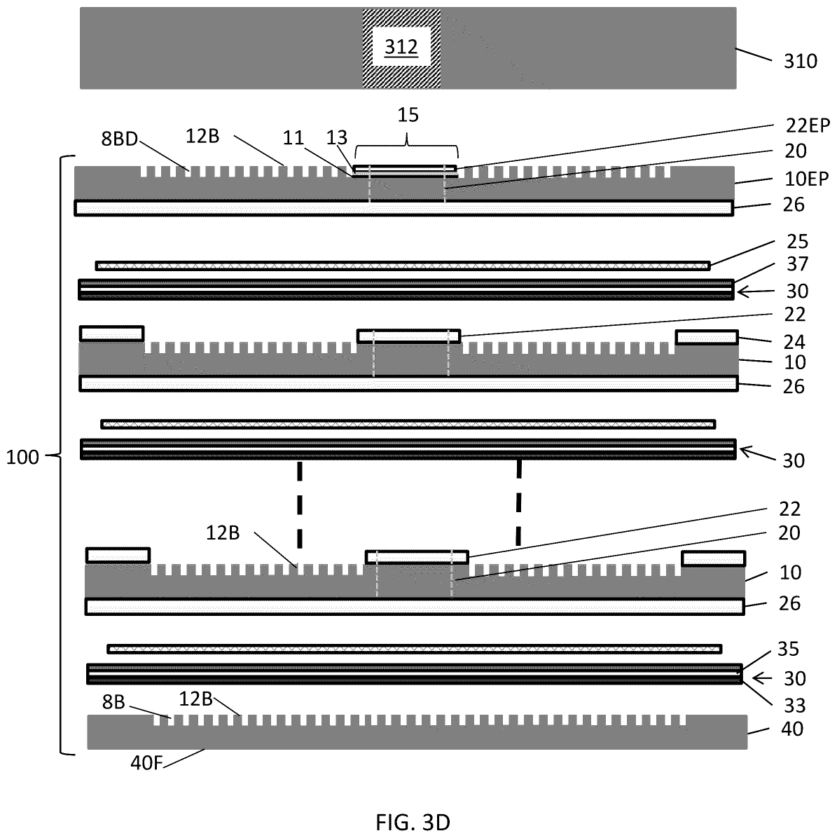

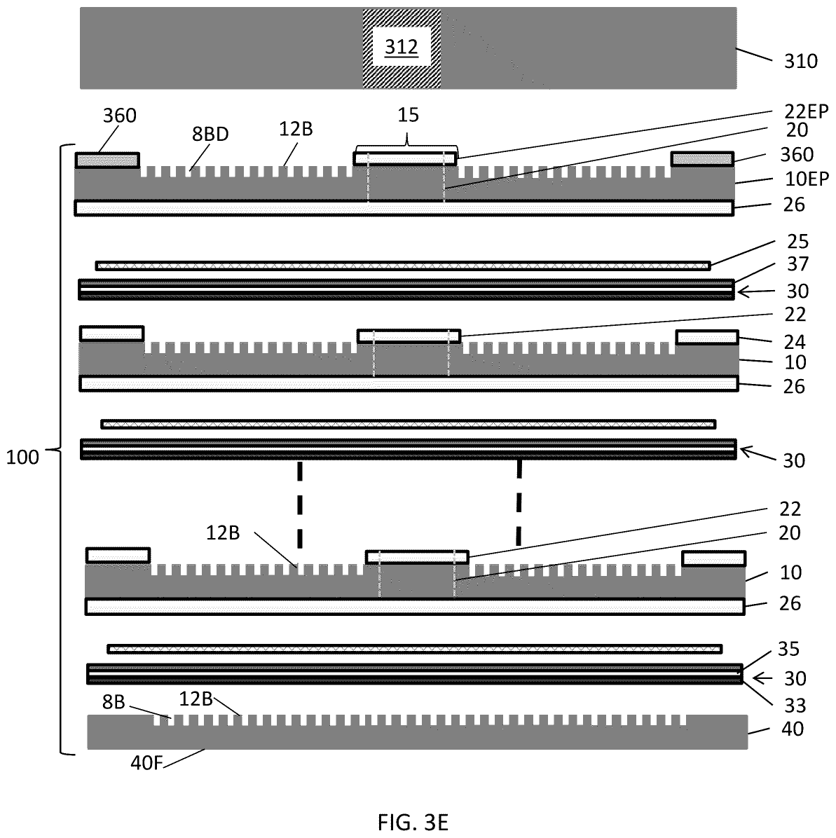

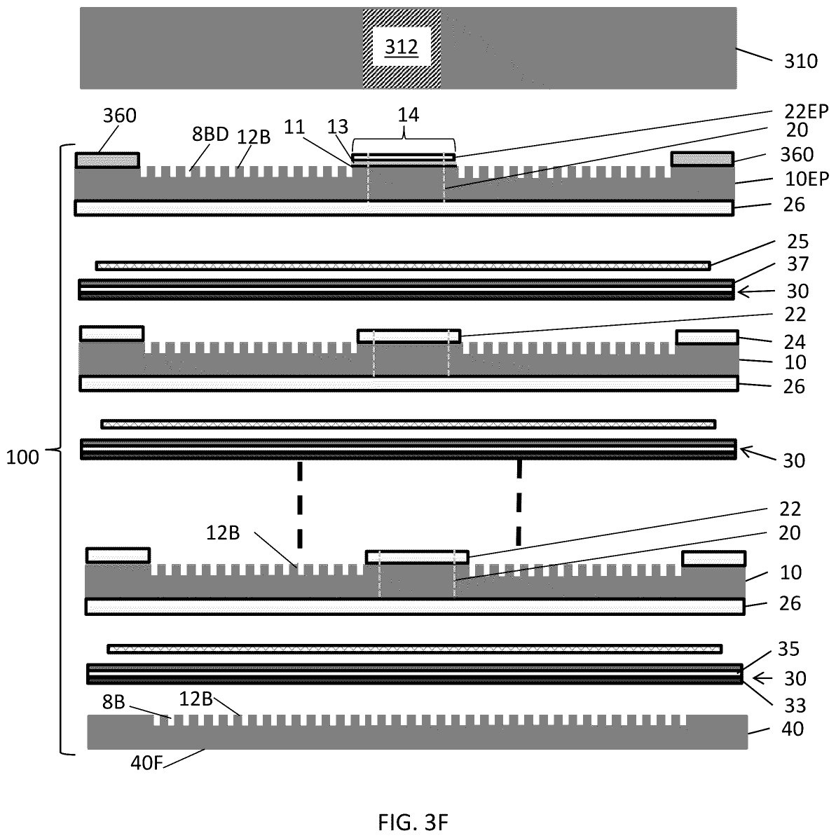

FIG. 3A is a perspective view of a fuel cell column 300, according to various embodiments of the present disclosure, FIG. 3B is an exploded cross-sectional view of a portion of the fuel cell column 300 according to one embodiment, and FIG. 3C is top view of an interconnect end plate of a fuel cell stack 100 that may be included in the fuel cell column 300, according to various embodiments of the present disclosure.

Referring to FIGS. 3A and 3B, the fuel cell column 300 may include multiple fuel cell stacks 100, a fuel inlet conduit 302, an anode (i.e., fuel) exhaust conduit 304, termination plates 306, and fuel manifolds 310 (e.g., anode splitter plates). The fuel inlet conduit 302 is fluidly connected to the fuel manifolds 310 and is configured to provide the fuel feed to each fuel manifold 310, and anode exhaust conduit 304 is fluidly connected to the fuel manifolds 310 and is configured to receive anode fuel exhaust from each fuel manifolds 310.

The fuel manifolds 310 may be disposed between the stacks 100 and may be configured to provide a fuel feed to the stacks 100 and to receive anode fuel exhaust from the stacks 100. For example, the fuel manifolds 310 may be fluidly connected to internal fuel riser channels formed by aligning the fuel holes 20 of the interconnects 10, as discussed above. In particular, the fuel manifolds 310 may include fuel holes 312 that are vertically aligned with the fuel riser channels/fuel holes 20, and fuel channels 314 that fluidly connect the fuel holes 312 with the respective the fuel inlet conduit 302 and the anode exhaust conduit 304.

The fuel cell column 300 may also include a compression assembly 340 and side baffles 350 disposed on opposing sides of the stacked fuel cells 100. The side baffles 350 may be formed of a ceramic material and may be connected to the compression assembly 340 and an underlying stack component (not shown) by ceramic connectors 352. The compression assembly 340 may be configured to apply pressure to and/or compress the stacks 100, so as to seal the stacks 100 to adjacent components (e.g., fuel manifolds 310).

Each stack 100 may include any suitable number of interconnects 10, such as from 5 to 40 interconnects 10, or from 10 to 35 interconnects 10, and a corresponding number of fuel cells 30 disposed therebetween. The stacks 100 may also include conductive layers 25, such as a nickel mesh, disposed between the fuel side of each interconnect 10 and the anode 37 of an adjacent fuel cell 30, to electrically connect the fuel cells 30 and interconnects 10 of the stack 100.

Each stack 100 may also include an interconnect end plate 10EP, which may be disposed at a fuel side end of the stack 100, and an air end plate 40 disposed at an air side of the stack 100. In particular, the interconnect end plate 10EP may be disposed on the fuel side (e.g., over the anode electrode 37) of an outermost (e.g., uppermost or lowermost) fuel cell 30 of the stack 100. The air end plate 40 may be disposed on the air side (e.g., over the cathode electrode 33) of an outermost (e.g., uppermost or lowermost) fuel cell 30 of the stack 100.

In various embodiments, the interconnect end plate 10EP may be a modified interconnect 10. For example, the interconnect end plate 10EP may include dummy air channels 8BD, strip seal regions 16 and fuel holes 20 (as shown in FIGS. 3B and 3C), as well as fuel channels 8A, fuel manifolds 28 and frame seal region 18 (as shown in FIG. 2B). The dummy air channels 8BD may be the same as the air channels 8B shown in FIGS. 2A and 3B, except that there is no cathode 37 of a fuel cell 30 which forms a horizontal surface of the dummy air channels 8BD. Instead, a fuel manifold 310 may contact the air ribs 12B of the interconnect end plate 10EP and form a horizontal surface (e.g., top surface or bottom surface depending on stack 100 orientation) of the dummy air channels 8BD.

In contrast, the air end plate 40 may have a flat surface 40F opposing the air ribs 12B and air channels 8B, as shown in FIG. 3B. The flat surface 40F lacks fuel channels 8A and fuel ribs 12A. The flat surface 40F may be placed against a fuel manifold 310 (if the stack 100 containing the air end plate 40 is the not the bottom most stack in the column 300) or a termination plate 306 (if the stack 100 containing the air end plate 40 is the bottom most stack in the column 300).

The interconnect end plate 10EP may include recessed ring seal regions 15 configured to receive an end plate ring seal 22EP. In particular, the ring seal regions 15 may be formed by removing a portion of the protective layer 11 (shown in FIG. 1B) from the ring seal regions. By removing the protective layer 11 from the recessed ring seal region 15, an undesirable chemical reaction between manganese diffusing out of an LSM and/or MCO containing protective layer 11 and the end plate ring seal 22EP is avoided. The chemical reaction may damage the end plate ring seal 22EP by corrosion of the seal material due to a reaction with the diffused manganese.

In various embodiments, the interconnect end plates 10EP may be interconnects that are processed before or after the interconnect end plates 10EP are attached to a fuel cell stack 100. For example, the ring seal regions on the air sides of the interconnect end plates 10EP may be subjected to grit blasting to locally remove the protective layer from the ring seal regions to form the recessed ring seal regions 15. However, any other suitable protective layer 11 removal method, such as laser ablation, mechanical scraping, etc., may be used to form the recessed ring seal regions 15. In contrast, the protective layer 11 is not removed in the ring seal regions 14 of the remaining interconnects 10 in the stack 100. Thus, the protective layer 11 covers the ring seal regions 14 of the remaining interconnects 10 in the stack 100.

In one optional embodiment, after removing the protective layer 11, the recessed ring seal regions 15 may be additionally locally thinned, such that the surface of each recessed ring seal region 15 may be recessed below the tops of the air ribs 12B. In other words, in one embodiment, the thickness of the interconnect end plate 10EP at the recessed ring seal regions 15 may be less than a corresponding thickness of the remaining interconnects 10 in the stack 100 at the ring seal regions 14. In some embodiments, the recessed ring seal regions 15 may be recessed at a depth that is approximately equal to a thickness of the end plate ring seals 22EP disposed thereon, such that an upper surface of the end plate ring seal 22EP disposed on the ring seal region 15 is substantially coplanar with the tops of the air ribs 12B and the strip seal regions 16. Thus, in one embodiment, the recessed ring seal regions 15 are recessed with respect to tops of the air ribs 12B of the interconnect end plate 10EP, while the ring seal regions 14 are not recessed with respect to tops of the air ribs 12B of the interconnects 10.

For example, in some embodiments, the depth of the recessed ring seal regions 15 may be slightly less (e.g., from about 1% to about 10%, or about 5%) than an initial thickness of the end plate ring seals 22EP. The fuel cell stacks 100 may be assembled and then stacked in the fuel cell column 300. The fuel cell column 300 may then be sintered. During sintering, heat and pressure applied to the stacks 100 may cause the seals 22, 22EP, 24, 26 to reflow. In particular, the end plate ring seals 22EP may reflow, such that the tops of the end plate ring seals 22EP are approximately coplanar with the tops of the air ribs 12B of the interconnect end plates 10EP. Accordingly, the recessed ring seal regions 15 may be configured to reduce and/or prevent damage to fuel cells 30 and/or interconnects 10 of the fuel cell stacks 100, which may otherwise occur if the end plate ring seals 22EP protruded above the tops of the air ribs 12B of the interconnect end plate 10EP. In other words, the recess of the ring seal regions 15 may reduce and/or prevent pressure from being concentrated on regions of adjacent fuel cells 30 which underly the recessed ring seal regions 15, due to the protrusion of the end plate ring seals 22EP from the interconnect end plate 10EP.

In an alternative embodiment illustrated in FIG. 3D, the recessed ring seal regions 15 may be locally thinned, such that the surface of each recessed ring seal region 15 may be recessed below the tops of the air ribs 12B, prior to forming the protective layer 11. In this alternative embodiment, the protective layer 11 may be deposited over the recessed ring seal regions 15 after they are locally thinned. In this alternative embodiment, a corrosion barrier layer (CBL) 13 may be formed between the protective layer 11 and the ring seals 22. The CBL 13 may comprise a glass-ceramic composite material configured to limit diffusion of manganese and/or manganese species from the protective layer 11 into the adjacent glass seals, such as the ring seals 22. The CBL 13 may include crystalline phases distributed in a glassy (e.g., amorphous) matrix phase. In some embodiments, the crystalline phase may include zirconium silicate (ZrSiO₄) crystals and/or magnesium aluminosilicate crystals, such as barium magnesium aluminosilicate crystals or barium free magnesium aluminosilicate crystals. The crystalline phase may additionally include calcium silicate crystals, such as calcium magnesium silicate crystals, calcium aluminosilicate crystals and/or magnesium-free and aluminum-free calcium silicate crystals.

Thus, in the alternative embodiment of FIG. 3D, the recessed ring seal regions 15 are recessed with respect to tops of the air ribs 12B of the interconnect end plate 10EP. The interconnect end plate 10EP comprises an interconnect end plate protective layer 11 covering the air ribs 12B, the dummy air channels 8BD and the recessed ring seal regions 15 on the air side. A corrosion barrier layer 13 is located between the interconnect end plate protective layer 11 and the interconnect end plate ring seals 22EP in the recessed ring seal regions 15.

Without thinning the recessed ring seal regions 15, the end plate ring seals 22EP stick up over the tops of the air ribs 12B of the interconnect end plate 10EP. In another alternative embodiment shown in FIG. 3E, at least one shim 360 may be provided between the interconnect end plate 10EP and the adjacent fuel manifold 310 instead of or in addition to locally thinning the recessed seal region of the interconnect end plate 10EP. The shim 360 may comprise a metal material (e.g., the same chromium iron alloy as the interconnects 10 or a different metal alloy, such as Inconel) or a ceramic material (e.g., alumina or stabilized zirconia, such as SSZ or YSZ). The top of the shim 360 may be in the same horizontal plane as the top of the end plate ring seal 22EP after stack sintering. The shim 360 more evenly redistributes the pressure applied by the fuel manifold 310 to the underlying stack 100 components and reduces the pressure on region of an underlying fuel cell 30 which underlies the recessed ring seal regions 15 and the end plate ring seal 22EP which sticks up over the tops of the air ribs 12B of the interconnect end plate 10EP.

In yet another alternative embodiment illustrated in FIG. 3F, the ring seal regions 14 are not locally thinned, and the protective layer 11 is located in the ring seal regions 14. The CBL 13 described above with respect to FIG. 3D is formed over the protective layer 11 in the ring seal regions 14, such that the CBL 13 is located between the protective layer and the end plate ring seal 22EP. In this alternative embodiment, the at least one shim 360 is provided between the interconnect end plate 10EP and the adjacent fuel manifold 310. The top of the shim 360 may be in the same horizontal plane as the top of the end plate ring seal 22EP after stack sintering, and thus offsets the increased height of the ring seal regions 14 due to the presence of the CBL.

In various embodiments, the interconnect end plate 10EP may be produced in the same batch process, such as a power metallurgy process, as the interconnects 10 included in the stack 100. The powder metallurgy process may comprise compression of a powder containing Cr and Fe in a die press apparatus to form a green part followed by sintering the green part. As such, batch-to-batch variations between the interconnects 10 and the interconnect end plate 10EP can be avoided. For example, the shape and thermal expansion coefficients of the interconnects 10 and interconnect end plates 10EP that are produced in the same manufacturing batch may be more uniform than interconnects 10 and interconnect end plates 10EP that are formed in different batches.

The present inventors discovered that the recessed ring seal regions 15 reduce the accumulation of compressive stress around to the fuel holes of adjacent fuel cells. In particular, in comparative fuel cell stacks that include conventional interconnects as fuel end plates, compressive stress is concentrated on portions of fuel cells facing the ring seals, due to the protrusion of the ring seals from the surface of the comparative interconnect end plates. As a result, cracks may form in the fuel cells due to the compressive stress. In addition, the present inventors discovered that the protective layer covering ring seal regions of interconnect end plates produces corrosion of the glass ring seal material. Thus, the removal of the manganese containing protective layer from the recessed ring seal regions reduces or avoids corrosion of the ring seal material on the fuel side interconnect end plate.

According to various embodiments, interconnect fuel end plates provide various unexpected benefits, as compared to conventional stack configurations that utilize a specialized fuel end plate. In particular, the use of interconnect fuel end plates allows for the omission of relatively the expensive conventional fuel end plates, which reduces stack manufacturing costs. In addition, overall stack production yield may be increased due to the elimination or reduction of separation between fuel end plates and adjacent stack components. Fuel cell systems of the embodiments of the present disclosure are designed to reduce greenhouse gas emissions and have a positive impact on the climate.

The interconnect end plate 10EP was described above as a fuel end plate for a fuel cell stack, in which the anode is the fuel electrode and the cathode is the air electrode. In an alternative embodiment, the interconnect end plate 10EP may also be used as an end plate for an electrolyzer cell stack, such as a solid oxide electrolyzer cell (SOEC) stack. In the SOEC stack, the anode is the air electrode and the cathode is the fuel electrode. Thus, the electrode to which the fuel (e.g., hydrogen or hydrocarbon fuel in a SOFC, and water in a SOEC) is supplied may be referred to as the fuel electrode and the opposing electrode may be referred to as the air electrode in both SOFC and SOEC cells. Thus, any suitable electrochemical cells (e.g., fuel cells or electrolyzer cells) may be used with the interconnect end plate 10EP of the various embodiments.

Any one or more features from any one or more embodiments may be used in any suitable combination with any one or more features from one or more of the other embodiments. Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. An electrochemical cell stack, comprising:
electrochemical cells that each comprise a fuel electrode, an air electrode and an electrolyte disposed therebetween;
interconnects disposed between the electrochemical cells; and
an interconnect end plate disposed over the fuel electrode of an outermost one of the electrochemical cells, the interconnect end plate comprising:
a fuel side;
an opposing air side;
fuel ribs disposed on the fuel side and at least partially defining fuel channels;
air ribs disposed on the air side and at least partially defining dummy air channels;
fuel holes extending from the fuel side to the air side; and
recessed ring seal regions disposed on the air side surrounding the fuel holes.

2. The electrochemical cell stack of claim 1, further comprising end plate ring seals surrounding the fuel holes and disposed on the recessed ring seal regions.

3. The electrochemical cell stack of claim 2, wherein the interconnect end plate comprises an interconnect end plate protective layer covering the air ribs and the dummy air channels on the air side.

4. The electrochemical cell stack of claim 3, wherein the recessed ring seal regions are not covered by the interconnect end plate protective layer.

5. The electrochemical cell stack of claim 4, wherein each of the interconnects comprises:
fuel ribs disposed on the fuel side and at least partially defining fuel channels;
air ribs disposed on the air side and at least partially defining air channels;
fuel holes extending from the fuel side to the air side; and
ring seal regions disposed on the air side surrounding the fuel holes.

6. The electrochemical cell stack of claim 5, further comprising an interconnect protective layer disposed on air sides of the interconnects, wherein the interconnect protective layer covers the ring seal regions.

7. The electrochemical cell stack of claim 6, wherein the interconnect protective layer and the interconnect end plate protective layer comprise a same material.

8. The electrochemical cell stack of claim 6, wherein the interconnect protective layer and the interconnect end plate protective layer comprise at least one of lanthanum strontium manganate or manganese cobalt oxide spinel.

9. The electrochemical cell stack of claim 5, wherein the recessed seal regions are at least partially formed by removing portions of the protective layer.

10. The electrochemical cell stack of claim 5, wherein:
the recessed ring seal regions are recessed with respect to tops of the air ribs of the interconnect end plate; and
the ring seal regions are not recessed with respect to tops of the air ribs of the interconnects.

11. The electrochemical cell stack of claim 10, further comprising end plate ring seals disposed on the recessed ring seal regions, wherein top of the end plate ring seals are coplanar with tops of the air ribs.

12. The electrochemical cell stack of claim 2, wherein:
the recessed ring seal regions are recessed with respect to tops of the air ribs of the interconnect end plate;
the interconnect end plate comprises an interconnect end plate protective layer covering the air ribs, the dummy air channels and the recessed ring seal regions on the air side; and
a corrosion barrier layer is located between the interconnect end plate protective layer and the interconnect end plate ring seals in the recessed ring seal regions.

13. The electrochemical cell stack of claim 1, wherein the interconnect end plate and the interconnects are manufactured during a same batch manufacturing process.

14. The electrochemical cell stack of claim 1, wherein the electrochemical cells are solid oxide fuel cells or solid oxide electrolyzer cells.

15. An electrochemical cell stack column comprising:
electrochemical cell stacks of claim 1; and
fuel manifolds disposed between the electrochemical cell stacks.

16. The electrochemical cell stack column of claim 15, further comprising at least one shim located between the interconnect end plate an adjacent one of the fuel manifolds.

17. An electrochemical cell stack column, comprising:
a fuel manifold;
an electrochemical cell stack, comprising:
electrochemical cells that each comprise a fuel electrode, an air electrode and an electrolyte disposed therebetween;
interconnects disposed between the electrochemical cells; and
an interconnect end plate disposed over the fuel electrode of an outermost one of the electrochemical cells; and
at least one shim located between the interconnect end plate and the fuel manifold.

18. The electrochemical cell stack column of claim 17, wherein the interconnect end plate comprises:
a fuel side;
an opposing air side;
fuel ribs disposed on the fuel side and at least partially defining fuel channels;
air ribs disposed on the air side and at least partially defining dummy air channels;
fuel holes extending from the fuel side to the air side;
ring seal regions disposed on the air side surrounding the fuel holes;
an interconnect end plate protective layer covering the air ribs, the dummy air channels and the ring seal regions on the air side; and
a corrosion barrier layer located over the interconnect end plate protective layer in the ring seal regions.

19. A method, comprising:
providing interconnect end plate comprising:
a fuel side;
an opposing air side;
fuel ribs disposed on the fuel side and at least partially defining fuel channels;
air ribs disposed on the air side and at least partially defining dummy air channels;
fuel holes extending from the fuel side to the air side; and
ring seal regions disposed on the air side surrounding the fuel holes;
coating the air side of the interconnect end plate with a protective layer; and
removing the protective layer from the ring seal regions of the interconnect end plate to form recessed ring seal regions.

20. The method of claim 19, further comprising manufacturing the interconnect end plate and a plurality of interconnects during a same batch manufacturing process.

21. The method of claim 20, further comprising:
coating an air side of the interconnects with the protective layer; and
placing the end plate interconnect and the interconnects into a electrochemical cell stack containing electrochemical cells without removing the protective layer from ring seal regions of the interconnects.

22. The method of claim 21, wherein the removing the protective layer from the ring seal regions of the interconnect end plate occurs before placing the end plate interconnect into the electrochemical cell stack.

23. The method of claim 21, wherein the removing the protective layer from the ring seal regions of the interconnect end plate occurs after placing the end plate interconnect into the electrochemical cell stack.

24. The method of claim 19, wherein:
the protective layer comprises at least one of lanthanum strontium manganate or manganese cobalt oxide spinel; and
the removing the protective layer from the ring seal regions of the interconnect end plate comprises using grit blasting to remove the protective layer from the ring seal regions of the interconnect end plate.
